(19) United States
(12) Patent Application Publication
(10) Pub. No.: US 2005/0120698 A1
(43) Pub. Date: Jun. 9, 2005

(54) Apparatus and method of cutting and slicing vegetation

(76) Inventor: Manfred Schlasse, Hagen (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/003,778

(22) Filed: Dec. 3, 2004

(30) Foreign Application Priority Data
Dec. 9, 2003 (DE) 103 57 465.4

(51) Int. Cl. A01D 34/73

(52) U.S. Cl. 56/255

(57) ABSTRACT

An apparatus (1) for cutting and slicing vegetation (5) includes a vertical driven shaft (14). A first knife (11) is operatively connected to the shaft (14) to be rotated therewith in a sense of rotation (16) within a cutting plane (25) approximately parallel to the soil (4). The first knife (11) includes a first knife portion (17) and a second knife portion (19). The first knife portion (17) serves to cut off vegetation (5) from the soil (4) in a first angle position (9) of the vegetation (5). The second knife portion (19) serves to slice the cut vegetation (5) in a second angle position (22) of the vegetation (5). The second knife portion (19) is arranged to be declined in a radial direction. The second knife portion (19) is arranged to be inclined in a tangential direction with respect to the cutting plane (25) according to the sense of rotation such that the cut vegetation (5) is pressed towards the soil (4) by an air flow. The second knife (11) has a corresponding design. A first guiding element (8) serves to bend down the vegetation (5) into the first angle position (9). A second guiding element (21) serves to further bend down the cut vegetation (5) into the second angle position (22).

### CROSS REFERENCE TO RELATED APPLICATIONS

This application claims priority to co-pending German Patent Application No. 103 57 465.4 entitled “Verfahren und Vorrichtung zum Abschneiden und Zerschneiden von insbesondere hoch wachsendem Schnittgut”, filed Dec. 09, 2003.

### FIELD OF THE INVENTION

The present invention generally relates to an apparatus and a method of cutting and slicing material to be cut, especially high growing vegetation.

Vegetation is to be understood as including grass, stalks, grains and other plants which substantially grow in an upward direction and for which it is desired not only to cut off the respective material from the ground, but to further slice the material. The novel apparatus and method may especially be used for mulching, and especially in case the vegetation has not been cut for a longer period of time. The novel apparatus and method are especially suitable for cutting high-growing grass, as it for example occurs in marginal strips of highways or other roads.

### BACKGROUND OF THE INVENTION

An apparatus and a method for cutting and slicing vegetation are known from German Patent No. DE 100 39 834 C2. The known apparatus includes at least two knives being located in a housing. The apparatus includes a driven shaft being arranged to be approximately vertical. The knives are driven by the shaft such that they are rotated therewith in a sense of rotation within a cutting plane approximately parallel to the soil. A first surface-like guiding element of the housing bends down the vegetation into a first angle position according to the working direction. The vegetation is then cut off from the soil by a first knife portion. The first knife portion is arranged at a radial outside portion of the knife, and it is substantially horizontal. The second knife portion follows in a radial inward direction. The second knife portion is arranged to be inclined in a tangential direction with respect to the cutting plane such that the cut vegetation is pressed towards the soil by an air flow. The first knife portion serves for initial cutting of the vegetation. The second knife portion serves for slicing the cut vegetation. The second knife portion is arranged at angles of inclination which are directed radially downward and tangentially upward transverse to the cutting plane such that one attains a conveying effect acting upon the vegetation in a conveying direction which is directed towards the ground and which is determined by the tangential angle of inclination.

According to the known method, the vegetation which substantially grows upright is moved to reach a declined position towards the working direction, and it is then cut off from the ground. The movement towards the forwardly declined position and the cutting action may be realized more or less simultaneously or short after one another. The working direction is to be understood as the direction in which the mowing apparatus, for example, is moved along the ground to mow certain surfaces. The vegetation is cut off from the ground with a first cut such that one attains a usually comparatively long stalk which has been separated from its stubble including its root. A majority of such stalks forms a wall of stalks which is then bent down in the working direction to be cut in this position. The cut off stalks of the wall of stalks move in a forward downward direction such that they contact the stalks which have not yet been cut. In a second step, the forwardly declined cut vegetation is then sliced in an approximately perpendicular direction. The cutting direction of this slicing operation is directed perpendicular to the main direction of the stalks such that the material is sliced at a small surface which results in advantageous low force requirement. The part and the space, respectively, above the cutting plane remains substantially free from cut vegetation. There is no danger of clogging. The cut and sliced vegetation is conveyed in a downward direction, and it reaches a compressed swath position in which it easily rottens.

The known method could also be called a “vertical chopping” method, and the corresponding apparatus could also be called a “vertical chopping” machine opposed to (also known) “horizontal chopping” machines which include a horizontal shaft. Nevertheless, the known method and apparatus have a lot more in common with rotary mowers. This especially applies to the number of knives used.

The known apparatus includes a guiding element being located at its housing. The guiding element has a surface, and it extends perpendicular to the working direction and to be spaced apart from the cutting circuit of the knives in a tangential direction. The angle position of the bent vegetation during cutting defined by the guiding element varies over the working width. Thus, there are different conditions over the working width during initial cutting and also during following slicing of the material. Although the knife portion effecting initial cutting is located to be horizontal, one attains a trough-shaped cut surface transverse to the working direction. The locally identical angle positions are neither optimal for initial cutting nor for slicing.

Depending on the direction of rotation of the knives, the material to be cut is compressed at the respective side of the housing of the apparatus. The compression effect occurs in a region in which the slicing effect decreases. There is the danger of the cut vegetation which not been sufficiently sliced exiting above the knives and below the housing in a rear direction or even leading to clogging effects at that place.

Another apparatus is known from German Patent No. DE 42 02 865 C2 corresponding to European Patent No. EP 0 554 560 B1. The apparatus is designed as a lawn mower including a movable housing. Such mowers are also designated as rotary mowers. The mover includes a plurality of knives which are located at a knife carrier. The knives rotate in a cutting plane which is approximately horizontal. They are rotatingly driven in the direction of rotation by an approximately vertical shaft. A part of the knife is arranged to be inclined with respect to the cutting plane in the direction of rotation to produce a flow of air being upwardly directed towards a space being surrounded by the housing. This flow of air serves to transport the cut off material into the space between the cutting plane and the housing, and to keep it there in a swirled up way. Due to gravity, the material falls down towards the cutting plane, and it is partly contacted and sliced by mulching knives and partly by knives being arranged on the knife carrier. Consequently, there is a certain chopping effect. However, the effect is only limited. Such mowers especially realize a good ground cut and a clean cutting surface when being used for cutting comparatively short grass. They fulfill their function at low production costs. Such known mowers have a comparatively low cutting force requirement. The number of knives is limited and thus advantageously low. However, the slicing effect can only be reached to a certain extent such that no real chopping is attained. When using such known mowers, there always is a substantial danger of clogging which requires interruption of mowing and which has a negative effect on the cutting surface. Another drawback is the fact that the cut material is placed in a comparatively soft and massive “carpet”. This has a negative effect on the rotting process of the cut material.

Another method and apparatus are known from U.S. patent No. 5,711,141. The known apparatus includes a knife arm which is rotatingly driven about an approximately vertical shaft in a direction of rotation. The two portions of the knife arm which extend in a radial direction from the shaft towards the outside have the same design as seen from the inside towards the outside. The radial outer portions are arranged to be inclined in an upward direction at the side facing away from the cutting edge such that an upwardly directed airflow is produced by these portions. This airflow has a lifting effect on the vegetation which has also been cut by these outer portions. Additional portions are designed and arranged at approximately two thirds of the radial extension of the two portions of the knife arms. The respective rear portion of these portions is designed to be lower in the direction of rotation than the front portion. In this way, a downwardly directed airflow is produced, the airflow being intended to subject a downwardly directed force onto the cut material, the material being then sliced in this portion. The desired slicing effect requires invertion of the direction of movement of the cut material. Whether or not the cut vegetation inverts its direction of movement is substantially determined by the housing-like surrounding of the knife arm the shape of which is not described in this prior art document. In any case, there are substantially higher local velocities in the radial outer portions due to the increase of the diameter than radially further inside. This means that the lifting effect onto the cut vegetation is substantially greater than the pressing down effect. Consequently, there still is the danger of clogging. Furthermore, it is not ensured that the entire cut material or at least great portions thereof move in a radial inward direction to reach a portion in which the cut material may be sliced.

A sickle mowing machine is known from German Patent No. DE 44 34 272 C1 corresponding to European Patent No. EP 0 782 380 B1. The known sickle mowing machine includes a rotatingly driven knife the cutting edges of which are arranged to be straight and continuous in the cutting plane. In the region of one of the arms, the portion opposite to the cutting edge is designed to be angled in an upward direction, and it thus forms a guiding blade. The other arm of the knife is designed to be angled in a downward direction, and it thus forms another guiding blade. One arm of the knife realizes an upwardly directed airflow, while the other arm causes a downwardly directed airflow. Due to the comparatively fast drive of the knife, these two effects will substantially compensate such that it is not possible to attain a significant stabilizing airflow. In this way, it is desired to slice the material for a plurality of times. However, an angled knife design is also known such that the cutting edges extend into a plurality of planes. The radial outer ends of the knife include guiding units to realize swirling up and pressing down of the cut material. This is realized in combination with a pot-like housing.

Furthermore, so-called flail type mowers are generally known in the art. However, these flail type mowers have a substantially different construction with respect to the arrangement of their elements. Flail type mowers include a horizontal shaft to which a majority of pivotally suspended flail knives is connected. When the horizontal shaft is driven, the flail knives move in vertical circuits. Such flail type mowers “mill” the vegetation to be cut. The flail knives are aligned due to the effect of the centrifugal force, and they can evade when contacting obstacles. Such flail type mowers realize excellent chopping results. The vegetation to be cut is evenly and finely sliced. The sliced vegetation usually is placed in a thin swath in a compressed way which has a positive influence on the rotting process. However, due to their special design, flail type mowers are more complicated than sickle mowers (or rotary mowers). The number of flail knives is substantially greater than the number of knives in sickle mower. Usually, the mowing unit carrying the flail knives has to be balanced, and it requires comparatively greater cutting forces. Due to the fact that the driving shaft is arranged to be horizontal, it is usually necessary to use an angular transmission to transmit the torque from a motor having a vertical axle to the horizontally arranged driving axle.

A lawn mower is known from German Patent Application No. DE 199 47 416 A1. The lawn mower includes two guiding elements in the form of two rows of prongs in front of the rotating knife. The prongs of the second row of prongs engage gaps of the prongs of the first row of prongs, and they are adjustable in height such the gaps of the prongs of the first row of prongs may be more or less closed. The vegetation to be cut is aligned by the two cooperating rows of prongs such that the cutting quality is improved even when cutting high growing material to be cut.

Another mower is known from European Patent No. EP 0 498 294 B1 corresponding to U.S. patent No. 5,191,756. The mower includes a substantially vertical wall of a housing and at least one driven mowing knife. A mulching sheet being located inside of the housing is associated with the mowing knife. The mulching sheet serves to bring back the cut material with respect to the mowing knife such that the material is subjected to a slicing process.

### SUMMARY OF THE INVENTION

The present invention relates to an apparatus for cutting and slicing vegetation. The apparatus includes a driven shaft being arranged to be approximately vertical. A first knife is operatively connected to the shaft to be rotated therewith in a sense of rotation within a cutting plane approximately parallel to the soil. The first knife includes a first knife portion and a second knife portion. The first knife portion is designed and arranged to cut off vegetation from the soil in a first angle position of the vegetation. The second knife portion is designed and arranged to slice the cut vegetation in a second angle position of the vegetation. The second knife portion is arranged to be declined in a radial direction. The second knife portion is arranged to be inclined in a tangential direction with respect to the cutting plane according to the sense of rotation such that the cut vegetation is pressed towards the soil by an air flow. The second knife has a corresponding design. A first guiding element is designed and arranged to bend down the vegetation into the first angle position. A second guiding element is designed and arranged to further bend down the cut vegetation into the second angle position.

With the novel apparatus and method, it is possible to realize uniform cutting results of the vegetation over the working width of the apparatus without requiring great power. This applies to the process of initial cutting as well as to the following process of slicing the vegetation.

The formerly known one angle position of the vegetation to be cut which varies over the working width is split up into two angle positions. The first angle position serves for initial cutting. The second angle position serves for the following slicing step. The two angle positions are determined differently. The term “cutting” is to be understood as relating to the first cut of the vegetation close to the soil with which the vegetation and the stalk, respectively, is cut off from the soil. The term “slicing” is to be understood as relating to the following steps in which the comparatively long piece of vegetation is separated into a plurality of sections, and to be chopped in this way. The step of cutting is a functional step separate from the act of slicing. Each of the two angle positions may be differently adjusted to optimally fulfill its respective function. The coordination is realized with respect to different portions of the knives. In this way, it is possible to realize the cuts substantially different with respect to the stalk of the vegetation to be cut during initial cutting as well as during the following slicing steps. Consequently, even less cutting force is required. In combination therewith, one attains excellent chopping results which counteract the danger of clogging. The step of initial cutting may be realized more or less simultaneously to the step of bending the wall of stalks into the forwardly declined position (as seen in the working direction) according to the first angle position. This at least applies to the middle portion of the working width. The second angle position serving for slicing may be determined and positioned independent from the first angle position for cutting.

It makes sense with respect to the cutting process if the direction of the airflow produced by the respective portions of the knife is inverted compared to the one for slicing. A good and exact cut in a region close to the soil is realized during cutting if the stalks are aligned in an upward direction by the airflow. In other words, the vegetation is maintained in the elongated position by a pulling process. In this position, the stalks of the vegetation are aligned under the influence of a stretching effect such that the cutting process is positively influenced. There is no substantial conveying effect with respect to the vegetation since it is securely maintained in place by the adjacent vegetation due to its forwardly declined position. Due to the following invertion of the airflow in a downward direction, the cut vegetation is then fed to the slicing portions of the knives.

The vegetation to be cut cannot bend towards the sides in a direction transverse to the working direction when it is moved towards the first angle position in which it is forwardly declined as seen in the working direction. In this position, the vegetation is cut. The first angle position for cutting may be realized by one or more guiding elements which prevent lateral bending of the stalks of the vegetation. These first guiding elements may extend in a direction approximately perpendicular to the working direction. They supply sufficient friction to the stalks during bending such that the stalks only bend in the working direction. The cut off vegetation is then sliced for a plurality of times in the second angle position. The second angle position is independent from the first angle position. The conditions are substantially the same ones over the working width corresponding to the cutting circuit during conveying in the conveying direction directed towards the ground. The at least one second guiding element may be adapted to the cutting circuit independent from the shape and arrangement of the at least one first guiding element. This means that the shape may be arc-like or polygonal, for example.

The vegetation is cut by a first portion of the knives which protrudes in a radial outward direction. These portions of the knives are located at an angle of approximately between 10° to 25° with respect to the horizontal plane to be downwardly declined in a radial direction towards the outside. This angle region is coordinated with the shape of the bent vegetation, and it is considered a compromise. The compromise has the goal of realizing perpendicular cutting of the vegetation to attain low force requirements.

Similar applies to the slicing process. The cut vegetation to be sliced is sliced by a second portion of the knives which is arranged in a radial inner direction. These knife portions are located at an angle of approximately between 50° to 75° with respect to the horizontal plane to be downwardly declined in a radial direction from the inside towards the outside. This angle region is coordinated with the shape of the material to be sliced in its second angle position, and it is to be understood as a compromise. The compromise desires to attain perpendicular slicing of the vegetation and to thus realize low cutting force requirements.

The novel apparatus suitable for conducting the novel method includes first and second stationary guiding elements or respective guiding units which are fixedly located at the housing of the apparatus to be stationary, or which are formed by a part of the housing. The first guiding element serves to realize the first angle position of the vegetation for initial cutting purposes. The second guiding element serves for realizing the second angle position of the cut vegetation for following slicing purposes. The first guiding element serves to contact the vegetation, and to bend it towards the first angle position to attain optimal results of the cutting operation. For this purpose, it acts upon the cut off vegetation (which has not yet been sliced) in a way that the wall of stalks is bent down in a forward direction in the working direction to be supported by the material which has not yet been cut. This forwardly declined intermediate position is changed by the second guiding element. The cut material is moved towards the second angle position which is in a region of angles of approximately between 40° to 15° with respect to the vertical plane.

Corresponding to this forwardly declined position, the knives at least include parts or portions over which the cutting edge of the knife extends and which are positioned in a radial direction to be approximately perpendicularly declined or bent with respect to the extension of the declined vegetation. Consequently, the cut vegetation is sliced perpendicularly or at least approximately perpendicularly with respect to the main (longitudinal) extension of the vegetation. Secondly, this part or portion of the knife is arranged to be transversely upwardly inclined in the rotational direction or the circumferential direction such that the rotating movement of the knives results in a downwardly directed airflow (meaning an airflow directed towards the soil) by which the cut stalks of the vegetation are carried along such that they continuously enter the region of these knives to realize the chopping slicing effect. During this action, comparatively short sections of the vegetation are formed which are placed on the soil and which are spinned towards the soil, respectively, in a compressed sway according to their continued direction of movement in the front portion of the mowing units, meaning upstream of the driving shaft. The sliced vegetation thus reaches the soil position along the shortest path such that the danger of clogging above the knives is substantially eliminated. In this way, one advantageously realizes a chopping effect although the number of knives is comparatively small. The vegetation is chopped in a vertical direction.

The two angle positions determined by the two guiding elements vary over the working width. The design of the guiding elements is chosen such that the variation is as small as possible and such that the conditions for cutting and slicing are as constant as possible. The two angle positions are coordinated with the two knife portions. The first knife portion is located in a radial downward direction at an angle chosen from a region of angles of approximately between 50° and 75° with respect to the horizontal plane.

The first stationary guiding element includes a guiding edge which extends approximately perpendicular to the working direction. The guiding edge prevents the vegetation from bending in a lateral direction transverse to the working direction. The second stationary guiding element includes a guiding edge which extends similar to an arc or in a polygonal way corresponding to the cutting circuit. The guiding edge moves the cut vegetation into the second angle position, the conditions remaining approximately constant over the working width.

In an especially simple embodiment, the second guiding element may be designed as a bent tube the shape of which is coordinated with the shape of the cutting circuit in the front portion. The second stationary guiding element is arranged to be only slightly higher than the highest place of the rotatingly driven knives. The second stationary guiding element is arranged at a lower place than the housing covering the cutting circuit. The passage gap between the knives and the housing of the apparatus is sufficiently small or locked such that the cut and sliced vegetation cannot pass in a downward direction. In this way, the vegetation is prevented from winding up on the drive shaft of the knives.

The apparatus may include a locking element serving to prevent passage of vegetation in a downward direction. The locking element is stationary, and it is arranged at the side determined by the direction of rotation of the knives. The locking element is fixedly connected to the housing. The shape of the locking element is coordinated with the shape of the two portions of the knife and the shape of the housing such that the passage cross-section between the path of movement of the knives and the housing is locked to a great extent.

The first knife portion ending at a radial outer place—as well as the second knife portion—includes a cutting edge which ends in a radial outward region as the lowest point of the knives. For this purpose, each knife may include a flattening located in the radial outer end portion and at the bottom side of the knife facing the soil. It is also possible to arrange a transversely ending leading edge at the free end of the knife for this purpose. Both possibilities prevent the wall of stalks of the vegetation which has not yet been cut from being compressed, and they thus prevent the cutting process from being negatively influenced.

The knives may include a radially protruding portion which subjects force onto the vegetation during cutting, the force being directed away from the soil in an upward direction. This portion is a free part of the knives which limits the cutting circuit in an outer direction and which first contacts the vegetation when the apparatus is moved forward according to the working direction. This part or portion fulfills the cutting function. During cutting, the vegetation which is still connected to the ground is pulled and aligned in an upward direction which has a positive influence on the cutting process. However, the airflow produced for this purpose is oriented in a different direction as it is required for the following step of slicing.

As seen in a radial direction from the inside towards the outside, the knives may first include an upwardly cranked portion followed by the downwardly declined portion serving for slicing and finally the protruding portion serving for cutting. The comparatively complicated design of the knives in a radial direction is preferably chosen such that the center of gravity of the cranked knives is nevertheless located in a plane determined by a knife support, for example a disc or an arm. In this way, no bending forces act upon the knives. The upwardly cranked inner portion of the knife then does not fulfill any cutting function, but it instead only serves for mass compensation. It is to be understood that this portion of the knife does not require the arrangement of a cutting edge. The cutting edge only needs to protrude along the two other parts and portions, respectively.

The stationary first and second guiding elements may also be divided into a plurality of sections which are arranged in relation to the path of movement of the knives. The first guiding element and it separate sections, respectively, is arranged perpendicularly and transverse to the working direction to allow for bending of the vegetation towards the front, on the one hand, and to prevent lateral bending and deflection of the vegetation, on the other hand. The design and arrangement of the second guiding element and of its sections, respectively, is preferably chosen in relation to the outer circumference of the cutting circuit, meaning with geometric association to the effect of the knives. In this way, when dividing the second guiding element into a plurality of sections, one attains a design which is symmetric with respect to the vertical longitudinal center plane, but which is stepped in a plurality of sections, for example three, four or five sections.

The simplest embodiment of the novel apparatus includes only one arm-like knife support being connected to the drive shaft to be commonly rotated therewith. A first knife is arranged at the first free end of the knife support, and a second knife is arranged at the second free end of the knife support. The entire apparatus thus includes the total number of two knives. It has a simple structure and nevertheless realizes surprisingly good chopping effects at low force requirements. It is to be understood that the working speed of this simplest embodiment of the apparatus is limited. The arrangement of the knives usually is realized in pairs using knife supports being designed similar to arms or bars. Disc-like knife carriers are not preferred since a part of the passage space for the sliced vegetation in a downward direction is covered and locked, respectively, by such disc-like knife supports. However, it makes sense to arrange a plurality of pairs of knives in a vertical spaced apart manner. When arranging two pairs of knives, the knives are arranged at approximately 90° with respect to one another. When using three pairs of knives, the angle between two knives is approximately 60° and so forth. However, it does not make much sense to drive a plurality of pairs of knives to rotate within one common cutting plane. It makes more sense to form a separate cutting plane with each pair of knives. These cutting planes are arranged one above the other in a vertical direction and in a spaced apart manner. The preferred and required, respectively, distance between the pairs of knives in a vertical direction results from the geometric conditions of the elements with respect to one another, especially from the angle of inclination of the second guiding element and the crank angle of the portions of the knife which fulfills the slicing effect. The vertical distance of the pairs of knives is coordinated with the angle of inclination of the inclined (or declined, respectively) position of the vegetation and uniform distribution of the slicing work onto the pairs of knives. In this way, each knife of different pairs of knives is uniformly stressed and used to supply cutting work. The respective portions of the knives providing the slicing effect are designed to be greater and longer, respectively, than it corresponds to the declination of the guiding element in the forward direction as seen in the working direction. In this way, it is taken into account that a cut wall of stalks of the vegetation always has the tendency to further fall down such that the vegetation contacts the respective portion of the knife during cutting at a flatter angle. To allow for clean slicing results, the respective portions of the knives are lengthened.

The rotatingly driven knives may be arranged in a cover-like housing. The front portion of the housing as seen in the working direction includes the guiding elements, and its portion protruding in a rear direction opposite the working direction may be designed to be tapered. This special design of the housing does not only fulfill the function of a housing, meaning to cover the knives rotating along the cutting circuit, but it also fulfills the function of the guiding sheet and the function of forming the sway deposit by the rear portion as seen in the working direction which is tapered. The taper may be chosen such that there are trapezoid cross-sections transverse to the working direction which allow for the arrangement of additional elements of the apparatus, especially wheels. The tapered cross-section further has an influence on the sway deposit of the cut and sliced vegetation.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a top view of a first exemplary embodiment of the novel apparatus.

FIG. 2 is a sectional view along line II-II in FIG. 1.

FIG. 3 is a sectional view along line III-III in FIG. 1.

FIG. 4 is a view of the apparatus in direction VI in FIG. 1.

FIG. 5 is a top view of a second exemplary embodiment of the novel apparatus.

FIG. 6 is a sectional view along line VI-VI in FIG. 5.

FIG. 7 is a sectional view along line VII-VII in FIG. 5.

FIG. 8 is a top view of a third exemplary embodiment of the novel apparatus.

FIG. 9 is a sectional view along line IX-IX in FIG. 8.

FIG. 10 is a sectional view along line X-X in FIG. 8.

FIG. 11 is a detailed view of a knife.

FIG. 12 is a sectional view along line XII-XII in FIG. 11.

FIG. 13 is a sectional view along line XIII-XIII in FIG. 11.

FIG. 14 is a view of a knife in the direction XIV in FIG. 11.

FIG. 15 is a top view of the knife in the direction XV in FIG. 11.

### DETAILED DESCRIPTION

Referring now in greater detail to the drawings, FIG. 1 illustrates a first exemplary embodiment of the novel apparatus 1. The apparatus 1 may be designed as a lawn mower only including one mowing drum, but also as a more complex mowing apparatus or a mowing bar including a plurality of adjacent mowing units. The apparatus 1 includes a housing 2 which is moved with respect to the soil 4 on wheels (not illustrated), for example, in the working direction of the apparatus 1. Vegetation 5 grows on the soil 4. The vegetation 5 may be any plants as, for example, grass including stalks as schematically illustrated in FIG. 1. The apparatus 1 is especially suitable for cutting high growing vegetation 5. The vegetation 5 is cut off from the soil 4 by the apparatus 1, and it is further sliced afterwards. The terms “cutting” and “slicing” are differentiated herein. Cutting is to be understood as relating to the first cut of the vegetation 5 close to the soil 4. With this first cut, each single stalk is cut in the cutting plane in the region of the soil 4 such that only stubbles 6 remain connected to the soil 4. The term “slicing” is meant to be understood as relating to a chopping process by which the vegetation 5 (which has already been separated from the soil 4) is divided into a plurality of sections. These sections have a comparatively short longitudinal extension compared to the long vegetation 5. The vegetation 5 is then either designated as the stubbles 6 or the cut vegetation 7. The cut vegetation 7 is placed in a compressed swath close to the soil 4 between the stubbles 6 in a way that it rottens quickly.

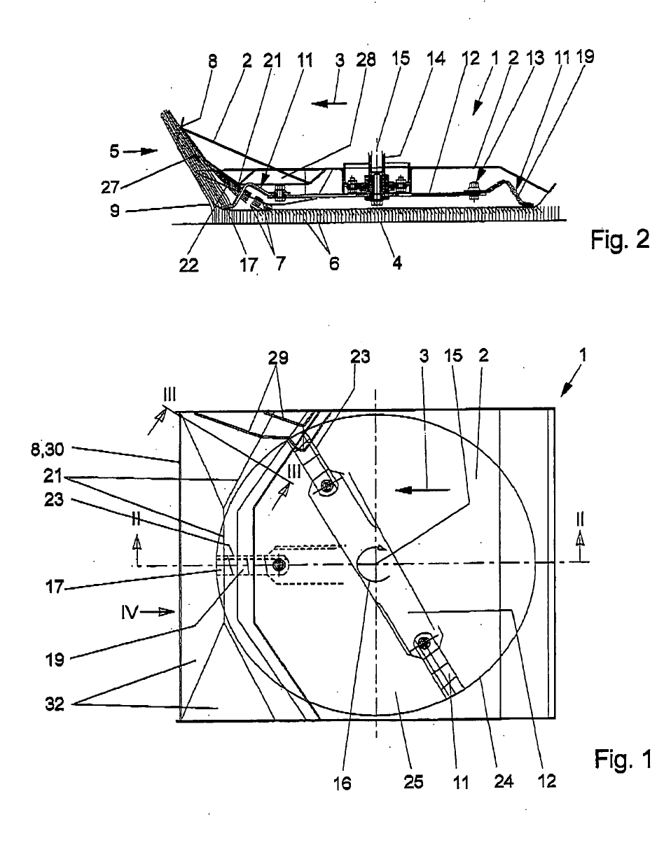

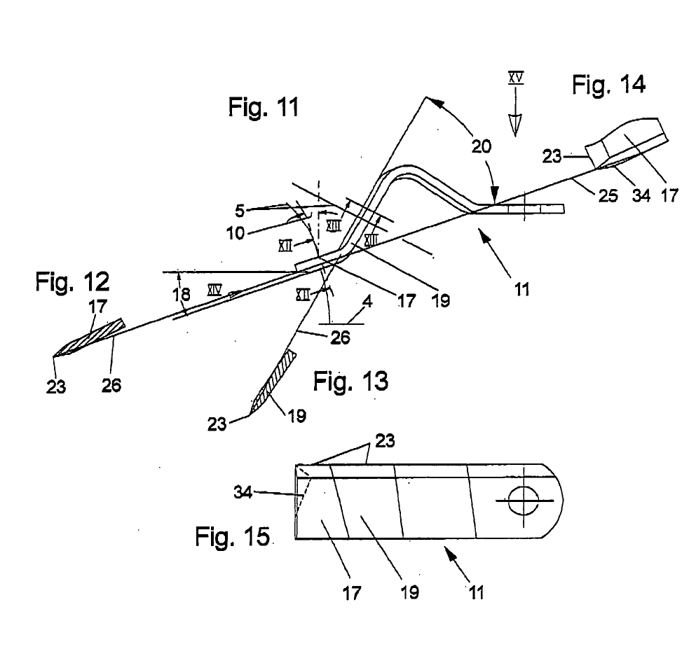

The housing 2 of the apparatus 1 in its front portion as seen in the working direction 3 includes a first guiding element 8 with which the more or less upright growing vegetation 5 is bent down into an inclined position towards the front to reach a first angle position 9 during the forward movement of the apparatus 1 in the working direction 3. The stalks of the vegetation 5 are supported at one another, as this is schematically illustrated in FIG. 2. The vegetation 5 in the forwardly inclined position corresponding to the angle position 9 has an angle of inclination 10 (FIG. 11) with respect to the vertical direction which is predetermined and influenced, respectively, by the respective design and arrangement of the guiding element 8 with respect to the cutting circuit and the knives.

The apparatus 1 includes knives 11 for initial cutting and further slicing of the vegetation 5. The exemplary embodiment of the apparatus 1 illustrated in FIGS. 1 and 2 include two knives 11 which are supported as the end of an arm-like knife support 12. The two knives 11 are illustrated by continuous lines in FIG. 1. Another position of the knives 11 is illustrated by a broken line. FIG. 2 illustrates the two knives 11 according to the position of the knives 11 illustrated by a broken line in FIG. 1. The knives 11 are usually arranged as pairs. Suspensions 13 are arranged at the free ends of the knife supports 12. The knives 11 are pivotally supported at the suspensions 13 such that they may reach their position illustrated in FIG. 1 under the influence of centrifugal force to fulfill their cutting work. For this purpose, the apparatus 1 includes a shaft 14 having an approximately or exactly vertical axis 15. The shaft 14 is driven by a drive (not illustrated), for example an electric motor or a combustion motor, in the sense of rotation 16 (FIG. 1). The arrangement, the drive and the support of the shaft 14 in the housing 2 are well-known in the art of disc mowing apparatuses and sickle mowing apparatuses such that they will not be explained herein in greater detail.

Each knife 11 has a characteristic bent shape as it is especially to be seen from FIGS. 2 and 11. As seen from a radial outward direction towards the inside, each knife 11 first includes a downwardly bent first knife portion 17. This knife portion 17 is bent in a downward direction in the radial direction at an angle 18 with respect to the horizontal plane. The angle 18 preferably is in a region of approximately 10° to 25°. The vegetation 5 is located at an angle of approximately 90° with respect to the knife portion 17 when it is cut with the knife portion 17. This means that it is cut approximately perpendicular with respect to its extension and position, respectively, and thus with the lowest possible cutting force. The knife portion 17 may be designed and arranged in a tangential direction such that its anticipating cuffing edge is located at a lower place than the following rear back of the knife. In this way, the knife portion 17 during its rotation produces an upwardly directed flow of air which pulls at and tightens the vegetation 5. This effect improves the cutting results. A second knife portion 19 is connected to the first knife portion 17 in a radial inward direction. The knife portion 19 is also bent in a downward direction in a radial direction at an angle 20 with respect to the horizontal plane which is approximately in a region of 50° to 75°. The second knife portion 19 serves for slicing the cut vegetation. The vegetation 5 is located at an angle of approximately 90° with respect to the knife portion 19 when it is sliced or chopped by the knife portion 19. This means that it is cut at a right angle with respect to its extension and its position, respectively. Consequently, slicing also requires a minimized cutting force. The knife portion 19 is designed and arranged in the tangential direction such that its anticipating cuffing edge is located higher than its following rear portion. The knife portion 19 during its rotation produces a downwardly directed flow of air which pulls the cut vegetation in a downward direction and conveys it. This effect improves slicing and conveying in a downward direction without problem.

A second guiding element 21 is located at the housing 2. The second guiding element 21 serves to move the cut vegetation into a second angle position 22. The second angle position 22 differs from the first angle position 9. The vegetation 5 in the second angle position 22 has an angle with respect to the vertical plane which corresponds to the angle 20 of the second knife portion 19 with respect to the horizontal plane. In this way, one attains above described perpendicular slicing of the vegetation 5 at low force requirements and good and even chopping effects.

An upwardly bent portion may be connected to the second knife portion 19 in a radial inward direction. This portion however does not fulfill any cuffing work. It serves for mass compensation of the outer portions of the knife 11. The knife portion 19 being bent in a downward direction is connected to this upwardly bent portion in aradial outward direction. The knife 11 ends in a radial outward direction in the first knife portion 17. The first knife portion 17 fulfills the cutting function for the vegetation 5, and it realizes the cut close to the soil 4 which results in separation from the stubbles 6. Each knife 11 has a cutting edge 23 which at least extends along the knife portions 17 and 19. The freely ending knife portion 17 of the two knives 11 are moved along a cutting circuit 24 during their rotation in the sense of rotation 16, the cutting circuit 24 being indicated in FIG. 1. The cutting circuit 24 covers a cutting plane 25 which is determined by the rotation of the protruding knife portion 17 of the knife 11. The cutting plane 25 usually is arranged to be horizontal. However, it may also have a slight declination in the working direction 3 towards the front, as this is known for realizing a free cut of the stubbles 6.

The portions or parts 17, 19 of the knife 11 have different positions in the circumferential direction, meaning the direction of rotation 16, as this is to be seen from FIGS. 11 to 14. Due to this wing-like or shovel-like arrangement, one attains air flows which serve to subject the vegetation 5 to an aligning effect and to a conveying effect. The portion or protruding part 17 of the knife 11 is arranged in a way which is to be seen in FIGS. 12 and 14. The relative position with respect to the rotational plane 26 is to be seen in FIGS. 12 and 14. The cutting edge 23 facing towards the front in the rotational direction 16 is located lower than the rear end of the knife 11 in this portion and in the part 17, respectively. In this way, when rotating the part 17, the vegetation 5 is subjected to a flow of air which is directed away from the soil 4 in an upward direction. In other words, the stalks of the vegetation 5 are pulled in an upward direction and they are tightened when they are cut. The portions 17 of each knife 11 only fulfill this tightening and cutting effect to the vegetation 5, meaning to cut the vegetation apart from the stubbles 6 remaining on the soil 4.

The portion or part 19 of the knife 11 has the opposite bent design in the circumferential direction. This is to be seen from the sectional views of FIGS. 12 and 13 which illustrate the relative position of the cross-section of the knife 11 in this portion relative to the rotational plane 26 and to the direction of rotation 16. Again, the cutting edge 23 anticipates in the direction of rotation 16. In this case, the cutting edge 23 is located higher above the rotational plane 26 than the rear end of each knife 11 in the portion 19. The portion 19 of the knives 11 is located at an angle which results in a flow of air in a downward direction towards the soil 4. In this way, one attains a conveying effect onto the cut stalks of the vegetation 5 in a conveying direction 27 being directed towards the soil 4. In this conveying direction 27, the stalks of the cut vegetation 5—which are guided by the second guiding element 21—are fed to the portion 19 of the knives 11. In the following, they are cut by the cutting edge 23 in the region of the portion 19 to become short sections of cut material 7. The air flow in the conveying direction 27 which is directed towards the soil 4 does not only result in the pulling effect acting upon the cut stalks of the vegetation 5 and the desired chopping effect, but it also realizes the desired compressed swath position of the cut vegetation 7 between the stubbles 6. It is especially advantageous if the air flow is not directed in an upward direction onto an intermediate space 28 between the knife support 12 and above the cutting plane 25 in the housing 2, respectively, as this is known in the prior art, Instead, the air flow moves the cut vegetation 7 with its sections in the front portion of the cutting plane 25 directly in a downward direction towards the soil 4 such that the intermediate space 28 usually remains completely free from cut vegetation 7 and there are no clogging effects at this place.

The angle of inclination of the portions 19 of the knives 11 may be in a region of approximately 5-10°. The protruding portions 17 of the knives 11 may also be located at a respective angle of inclination which is however directed in the opposite direction. This angle of inclination may also be in a region of approximately 5° to 10°.

The exemplary embodiment of the novel apparatus 1 according to FIGS. 1 to 4 especially in FIGS. 1 and 4 illustrate a locking element 29 being located at the right hand side of the housing 2 as seen in the working direction 3. The locking element 29 is arranged to be stationary, and it is interconnected with the housing 2. The locking element 29 is designed as a fitting and as a form body, respectively, which locks the free cross-section between the rotating knives 11 and the part of the housing 2 located above such that the cut vegetation 5 cannot move in a downward direction at this place against the working direction 3. The right hand side of the apparatus 1 with respect to the direction of rotation 16 forms a chamber in which cut vegetation 5 accumulates. Without the arrangement of a locking element 29, this place tends to clogging. The locking element 29 has the effect of the vegetation 5 which is located at this side in a compressed way cannot move in a downward direction without being cut. Instead, it is forced to be cut. Despite the unpreventable compression of the vegetation 5 at this place, the vegetation 5 is cut by the knife portions 19.

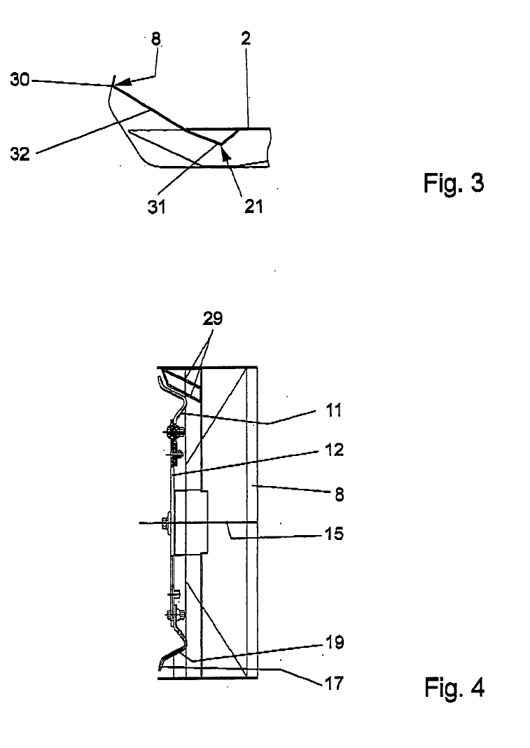

It is especially to be seen in FIGS. 1 and 3 that the guiding elements 8 and 21 of the housing 2 may be located at different heights and in different relative positions with respect to the working direction 3 to pre-form different angle positions. The guiding element 8 includes a guiding edge 30 as an important element. The guiding element 21 also includes a guiding edge 31. Both guiding elements 8 and 21 are interconnected by a saddle roof-like portion 32 to allow for the two different angle positions of the vegetation 5. The roof-like portion 32 may include a plurality of elements or sections as seen over the working width, as this is illustrated in FIG. 1. It is also to be seen from FIG. 1 that the first guiding element 8 with its guiding edge 30 extends straight and transverse to the working direction 3, while the second guiding element 21 has a polygon-like shape and is arranged relative to the circumference of the cutting circuit 24.

FIG. 4 illustrates the view of the apparatus 1 in the direction IV in FIG. 1. The knife support 12 with the knives 11 is illustrated in a position rotated about 90° with respect to FIG. 2. It is to be seen that the locking element 29 locks the passage between the knives 11 and the housing 2 in a rear direction.

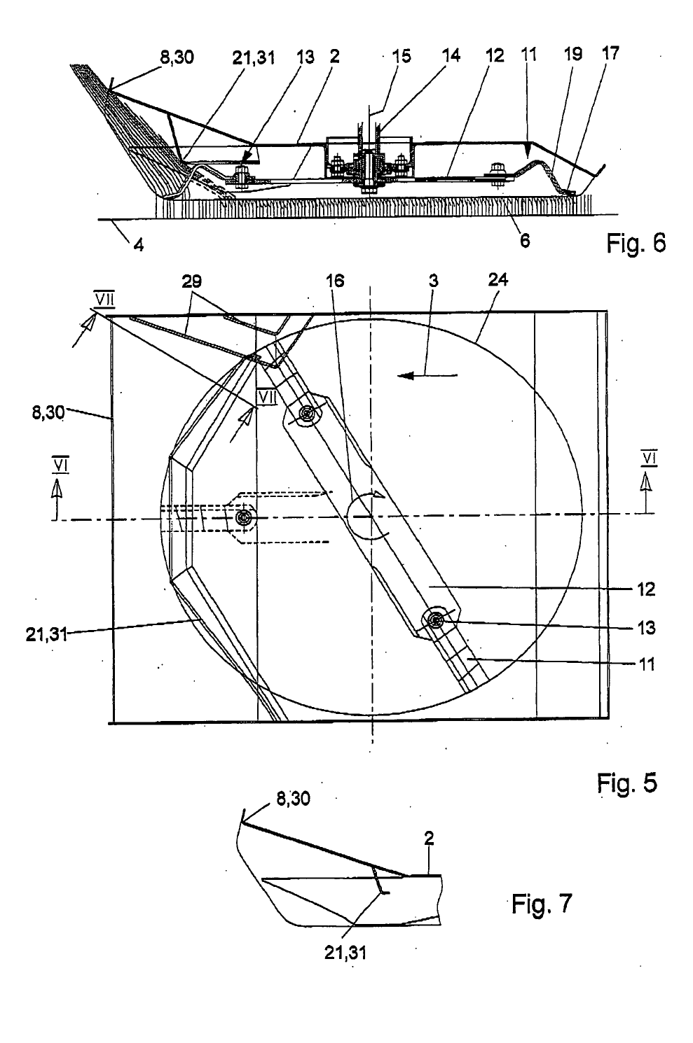

The embodiment of the novel apparatus 1 according to FIGS. 5 to 7 does not include a protruding roof-like portion 32 located between the guiding elements 8 and 21. The design is inverse compared to FIG. 2. The guiding elements 8 and 21 in FIG. 6 are substantially designed as guiding edges 30 and 31. Again, the guiding element 21 and the guiding edge 31, respectively, is located below the plane in which the housing 2 covering the cutting circuit 24. This arrangement serves to arrange the second guiding element 21 close to the knife 11. As it is to be seen in FIG. 5, it is also desired to design the second guiding element 21 to be similar to a polygon such that substantially similar cutting conditions prevail relative to the cutting circuit 21 over the working width.

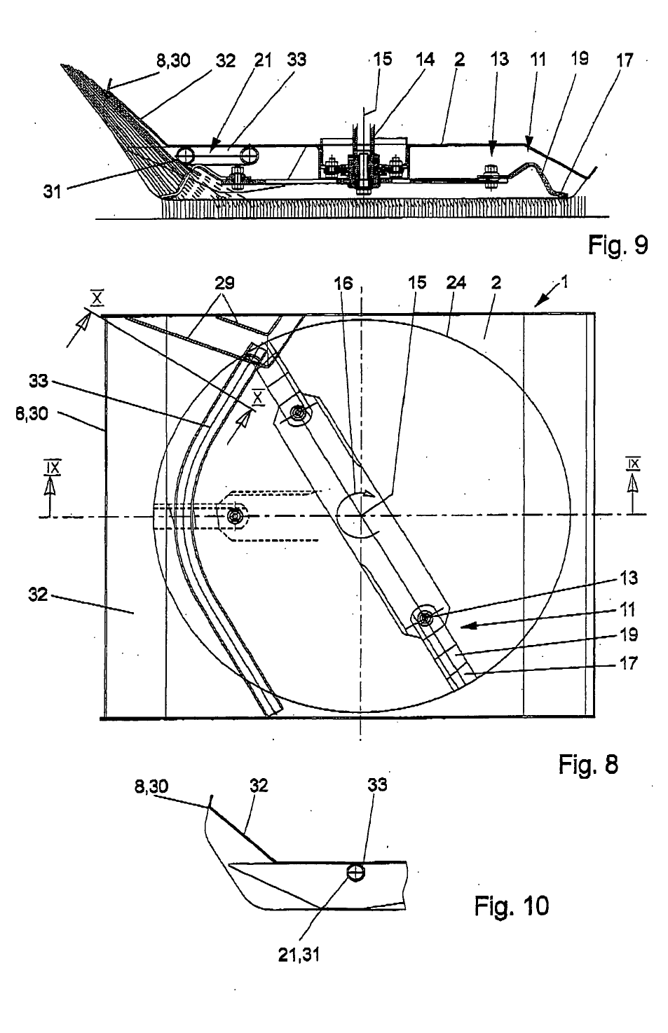

The embodiment of the novel apparatus 1 according to FIGS. 8 to 10 has a lot in common with the above described embodiments. Consequently, it is partly referred to the above descriptions. The second guiding element 21 is designed as a bent tube section 33 which is attached below the housing 2. The bent shape of the tube section 33 is coordinated with the circumference of the cutting circuit 24 to also attain approximately constant cutting conditions over the working width. The guiding edge 31 is formed by the lower portion of the tube section 33. The guiding edge 31 serves to ensure that the vegetation 5 after cutting is moved towards the second angle position 22 by the guiding element 21.

FIG. 11 illustrates the knife 11 illustrated in FIG. 2 at an enlarged scale. The knife 11 includes the knife portions 17 and 19 located in the respective angle positions. The first knife portion 17 is located at an angle 18 with respect to the horizontal plane in a radial direction. The angle 18 has a value of approximately between 10° to 25°. Only one single stalk of the vegetation 5 is illustrated in its declined position at the soil 4. It is to be seen that cutting is realized approximately perpendicular with respect to the stalk.

The second knife portion 19 is arranged at an angle 20 with respect to the horizontal plane in a radial outward direction. The angle 20 is angle chosen from approximately between 50°to 75°.

FIGS. 12 to 14 illustrate sectional views being rotated about different rotational planes 26. FIG. 14 shows that a flattening 34 begins at the lowest point of the cutting edge 23. The shape of the flattening 34 may also be seen in FIG. 15. The arrangement of the flattening 34 serves to prevent a point in the outer portion of the knife 11 which is located lower than the free end of the cutting edge 23. In this way, it is prevented that portions of the knife 11 following the cutting edge 23 push in or otherwise deform the vegetation 5 according to the direction of rotation 16. This has a positive influence on a clean cutting operation.

Many variations and modifications may be made to the preferred embodiments of the invention without departing substantially from the spirit and principles of the invention. All such modifications and variations are intended to be included herein within the scope of the present invention, as defined by the following claims.

1. An apparatus for cutting and slicing vegetation, comprising:
a shaft, said shaft being arranged to be approximately vertical;
a first knife, said first knife being operatively connected to said shaft to be rotated therewith in a sense of rotation within a cutting plane approximately parallel to the soil, said first knife including a first knife portion and a second knife portion,
said first knife portion being designed and arranged to cut off vegetation from the soil in a first angle position of the vegetation,
said second knife portion being designed and arranged to slice the cut vegetation in a second angle position of the vegetation, said second knife portion being arranged to be declined in a radial direction, said second knife portion being arranged to be inclined in a tangential direction with respect to the cutting plane according to the sense of rotation such that the cut vegetation is pressed towards the soil by an air flow;
a second knife, said second knife being operatively connected to said shaft to be rotated therewith in the sense of rotation within the cutting plane approximately parallel to the soil, said second knife including a first knife portion and a second knife portion,
said first knife portion being designed and arranged to cut off vegetation from the soil in the first angle position of the vegetation,
said second knife portion being designed and arranged to slice the cut vegetation in the second angle position of the vegetation, said second knife portion being arranged to be declined in a radial direction, said second knife portion being arranged to be inclined in a tangential direction with respect to the cutting plane according to the sense of rotation such that the cut vegetation is pressed towards the soil by an air flow;
a first guiding element, said first guiding element being designed and arranged to bend down the vegetation into the first angle position; and
a second guiding element, said second guiding element being designed and arranged to further bend down the cut vegetation into the second angle position.

2. The apparatus of claim 1, wherein said apparatus has a working width, said second guiding element being designed and arranged corresponding to the cutting circuit to supply substantially constant slicing conditions over the working width.

3. The apparatus of claim 1, wherein said first knife portion is arranged to be declined in a radial outward direction at an angle of between approximately 10° and 25°.

4. The apparatus of claim 2, wherein said first knife portion is arranged to be declined in a radial outward direction at an angle of between approximately 10° and 25°.

5. The apparatus of claim 1, wherein said second knife portion is arranged to be declined in a radial outward direction at an angle of between approximately 50° and 75°.

6. The apparatus of claim 2, wherein said second knife portion is arranged to be declined in a radial outward direction at an angle of between approximately 50° and 75°.

7. The apparatus of claim 3, wherein said second knife portion is arranged to be declined in a radial outward direction at an angle of between approximately 50° and 75°.

8. The apparatus of claim 1, wherein
said apparatus has a working direction,
said first guiding element includes a guiding edge, said guiding edge being designed and arranged to extend approximately perpendicular to the working direction, said guiding edge being designed and arranged to prevent the vegetation from bending in a lateral direction transverse to the working direction.

9. The apparatus of claim 2, wherein
said apparatus has a working direction,
said first guiding element includes a guiding edge, said guiding edge being designed and arranged to extend approximately perpendicular to the working direction, said guiding edge being designed and arranged to prevent the vegetation from bending in a lateral direction transverse to the working direction.

10. The apparatus of claim 1, wherein
said apparatus has a working width,
said second guiding element includes a guiding edge, said guiding edge being designed and arranged to extend approximately arc-like corresponding to the cutting circuit, said guiding edge being designed and arranged to move the vegetation into the second angle position to realize substantially constant conditions over the working width.

11. The apparatus of claim 2, wherein
said apparatus has a working width,
said second guiding element includes a guiding edge, said guiding edge being designed and arranged to extend approximately arc-like corresponding to the cutting circuit, said guiding edge being designed and arranged to move the vegetation into the second angle position to realize substantially constant conditions over the working width.

12. The apparatus of claim 8, wherein
said apparatus has a working width,
said second guiding element includes a guiding edge, said guiding edge being designed and arranged to extend approximately arc-like corresponding to the cutting circuit, said guiding edge being designed and arranged to move the vegetation into the second angle position to realize substantially constant conditions over the working width.

13. The apparatus of claim 10, wherein said guiding edge of said second guiding element is designed and arranged to be located only slightly higher than a highest place of said first knife and of said second knife.

14. The apparatus of claim 11, wherein said guiding edge of said second guiding element is designed and arranged to be located only slightly higher than a highest place of said first knife and of said second knife.

15. The apparatus of claim 1, further comprising a stationary locking element, said locking element being arranged at a side of said apparatus being determined by the sense or rotation, said locking element being designed and arranged to prevent passage of the cut vegetation in a rear direction.

16. The apparatus of claim 2, further comprising a stationary locking element, said locking element being arranged at a side of said apparatus being determined by the sense or rotation, said locking element being designed and arranged to prevent passage of the cut vegetation in a rear direction.

17. The apparatus of claim 1, wherein said first knife portion includes a cutting edge, said cutting edge being designed and arranged to end in a radial outward direction as the lowest point of said knife.

18. The apparatus of claim 2, wherein said first knife portion includes a cutting edge, said cutting edge being designed and arranged to end in a radial outward direction as the lowest point of said knife.
